(19) United States
(12) Patent Application Publication
(10) Pub. No.: US 2015/0347057 A1
(43) Pub. Date: Dec. 3, 2015

(54) STORAGE AREA NETWORK EMULATOR

(71) Applicant: NetApp, Inc., Sunnyvale, CA (US)

(72) Inventors: Chris A. Busick, Shrewsbury, MA (US); Subir K. Das, Bangalore (IN)

(21) Appl. No.: 14/604,534

(22) Filed: Jan. 23, 2015

(30) Foreign Application Priority Data
May 30, 2014 (IN) 1797/MUM/2014

(51) Int. Cl. G06F 3/06; G06F 17/50

(52) U.S. Cl. CPC G06F 3/0659; G06F 3/061; G06F 3/067; G06F 17/5009

(57) ABSTRACT

Some aspects of the disclosure describe a method for testing a storage controller by emulating storage area network (SAN) topologies and vendor-specific behavior in the storage controller. The method can include detecting, via a processor in the storage controller, a physical storage device connected to the storage controller. In response to detecting the physical storage device, the method can determine logic unit numbers (LUNs) based on device characteristics of the physical storage device, and determine a SAN topology to emulate, wherein the SAN topology defines paths leading to the LUNs. The method can also include updating, via the processor, configuration information used by components of the storage controller to indicate the paths leading to the LUNs. The method can also include detecting an input/out request that requires data associated with the LUNs. The method can also include determining, using the configuration information, the data associated with the LUNs.

### BACKGROUND

Storage area networks (SANs) can include many different components. SANs can include various storage controllers (e.g., V-Series storage controllers from NetApp® of Sunnyvale, Calif.), switches, storage arrays, cabling, etc. Typically, many of these components are made by different manufacturers, and can be configured according to various configuration options. For example, some configuration options allow SAN designers to configure SAN components according to different topologies. Typically, a given SAN topology accounts for numerous configurations across many SAN components. For example, some topologies configure paths from a storage controller's host bus adapters (HBAs) through switches, and on to storage array target ports. Additionally, these topologies can associate the storage array target ports with storage objects, such as logical unit numbers (LUNs) and logical devices. Such high interoperability and configurability provides flexibility for SAN designers. However, to build such interoperable and configurable SAN components, manufacturers must perform extensive research, design, and testing. As the number of SAN component makers increases, so does the need for tools that accelerate design and testing cycles for SAN component makers.

### OVERVIEW

Some aspects of the disclosure describe a method for testing a storage controller by emulating storage area network (SAN) topologies and vendor-specific behavior in the storage controller. The method can include detecting, via a processor in the storage controller, a physical storage device connected to the storage controller. In response to detecting the physical storage device, the method can determine logic unit numbers (LUNs) based on device characteristics of the physical storage device, and determine a SAN topology to emulate, wherein the SAN topology defines paths leading to the LUNs. The method can also include updating, via the processor, configuration information used by components of the storage controller to indicate the paths leading to the LUNs. The method can also include detecting an input/out request that requires data associated with the LUNs. The method can also include determining, using the configuration information, the data associated with the LUNs.

### BRIEF DESCRIPTION OF THE DRAWINGS

Some aspects of the present disclosure may be better understood, and numerous objects, features, and advantages made apparent to those skilled in the art by referencing the accompanying drawings.

FIG. 1 is a block diagram illustrating components and operations for emulating LUNs in a storage controller, according to some aspects of the disclosure.

FIG. 2 includes a block diagram illustrating an example SAN topology.

FIG. 4 is a block diagram illustrating a misconfigured SAN topology.

FIG. 5 is a block diagram illustrating another misconfigured SAN topology.

FIG. 6 is a block diagram illustrating an example architecture for a storage controller including a SAN emulator.

FIG. 7 is a block diagram illustrating a virtual storage controller including a SAN emulator.

FIG. 8 shows an example topology matrix used for configuring a SAN emulator.

FIG. 9 is a flow diagram illustrating operations for configuring data structures that indicate a SAN topology and LUN relationships in a SAN.

FIG. 10 shows data structures representing the SAN topology and LUN relationships of FIG. 11.

FIG. 11 shows an example SAN topology with LUN relationships.

FIG. 12 is a block diagram showing how a SAN emulator and other components of a storage controller can process SCSI I/O commands.

FIG. 13 depicts an example computer system with a cluster consistent logical storage object naming unit.

### DESCRIPTION

The description that follows includes example systems, methods, techniques, instruction sequences and computer program products relating to certain aspects of the disclosure. However, it is understood that the described aspects may be practiced without these specific details.

### Introduction

As described above, SAN components are highly interoperable and configurable. As a result, SAN designers/administrators can configure SAN components to implement a variety of topologies, and achieve a variety of performance objectives. These configurations define how storage controllers process I/O requests. For instance, storage controllers use topology information (provided by SAN administrator/designer) in determining where to retrieve specific data in a SAN. If SAN designers/administrators make configuration errors (e.g., misconfiguring relationships between LUNs and logical devices), SANs may lose, over write, or otherwise corrupt data. Misconfigurations are often difficult to predict and detect.

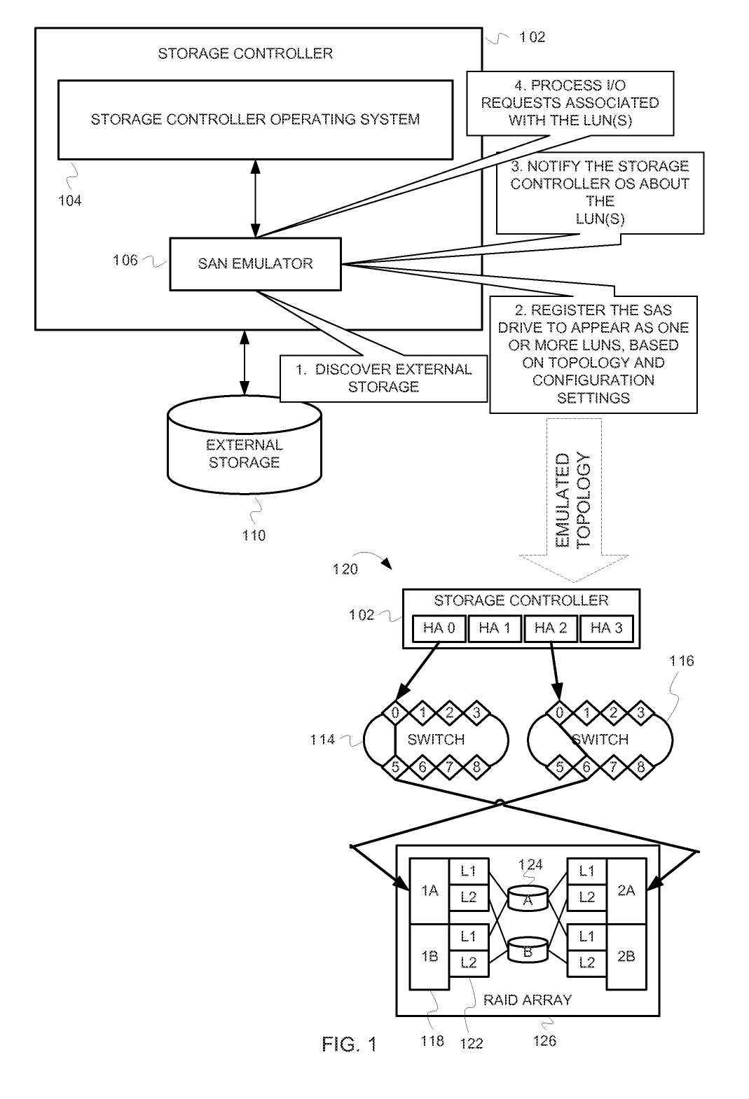

Some instances of the present disclosure emulate various SAN components without actually having those components in the SAN. By emulating SAN components, some instances enable quicker design and testing for numerous SAN devices. Some instances also help designers predict configuration errors unique to specific SAN devices. FIG. 1 shows how some instances emulate various topologies and configurations of particular devices, without actually having those devices in the SAN.

FIG. 1 is a block diagram illustrating components and operations for emulating SANs in a storage controller, according to some aspects of the disclosure. Although not shown (for simplicity), the storage controller 102 can be part of a SAN that includes a plurality of storage controllers, switches, RAID arrays, and other components. The storage controller 102 includes a storage controller operating system (OS) 104, and a SAN emulator 106. Other components (e.g., hardware, protocol stacks, etc.) are omitted for simplicity. The storage controller 102 is connected to external storage 110. The external storage 110 can include fiber channel RAID arrays, virtual machine storage (VMDKs), unstructured storage devices (e.g., a JBOB (Just a Bunch of Bytes)), or any other suitable storage means.

The SAN emulator 106 can emulate LUN configurations that may not be supported by components in the SAN. For example, the external storage 110 may be a single serial attached SCSI (Small Computer System Interface) (SAS) disk, which does not inherently support LUNs. However, the SAN emulator 106 can make the external storage 110 appear to the OS 104 as a RAID array supporting a plurality of LUNs. Additionally, the SAN emulator 106 can make the external storage 110 appear to the OS 104 as being part of a particular SAN topology. The following four stages of operation summarize how the SAN emulator 106 discovers devices and emulates various SAN topologies.

At stage 1, the SAN emulator 106 discovers the external storage 110. For example, the external storage 110 may become connected to the storage controller 102 via a host bus adapter. The SAN emulator 106 can detect the connection, and discover the external storage 110. As part of discovering the external storage 110, the SAN emulator 106 receives data indicating device characteristics of the external storage 110 (e.g., number of controllers, target port addresses, number of disks, etc.).

During stage 2, the SAN emulator 106 configures data structures to make the external storage 110 appear as having one or more LUNs for a given topology. As part of this process, the SAN emulator 106 reads a topology matrix to determine the given topology (i.e., connection paths between SAN devices, including the external storage 110). Based the topology and the device characteristics of the external storage 100 (e.g., number of controllers, target port addresses, number of disks, etc.), the SAN emulator 106 configures data structures that map one or more LUNs to the external storage 110. Design and test engineers may populate the topology matrix based on desired test cases, etc.

As an example, the SAN emulator 106 may emulate an example topology 120. According to the example topology 120, the storage controller's host bus adaptors (HA0 and HA2) are connected to a RAID array 126 via switches 114 and 116. The RAID array 126 includes four target ports 118 (1A, 1B, 2A, and 2B) each associated with LUNs 122 (L1 and L2). The LUNs 122 are mapped to two logical devices 124 (storage device A and storage device B) storing data.

During stage 3, the SAN emulator 106 notifies the storage controller OS 104 about the LUNs and topology. After receiving information about the LUNs and topology, the storage controller OS 104 will process I/O requests based on the LUNs and topology information. For example, after stage 3, the storage controller OS 104 will operate as if its host bus adapters HA0 and HA1 are connected to the switches 114 and 116, and as if the LUNs 122 reside in the RAID array 126.

During stage 4, the storage controller OS 104 processes I/O requests associated with the LUNs 122. As noted above, even though the external storage 110 does not inherently support LUNs, the storage controller OS 104 processes I/O requests relating to the LUNs 122, as if they are accessible via the topology 120.

Although FIG. 1 shows the SAN emulator residing in a storage controller and working in concert with a storage controller OS, the SAN emulator can operate in other environments. The SAN emulator can operate on any suitable computing device in concert with any suitable operating system. For example the SAN can operate on any general purpose computer in a Windows® environment, Linux® environment, Mac OS X® environment, etc.

### Example Topologies

Although there are numerous and varied uses for aspects of this disclosure, some uses relate to design and testing. When designing and testing storage controllers, engineers may want to simulate various topologies without procuring all the components needed to implement those topologies. For example, if a customer complains that a storage controller corrupts data for a given topology, engineers may want to simulate the topology to test aspects of the storage controller OS. As part of the testing process, engineers may utilize storage controllers in a farm of pre-connected SAN components. To set-up the SAN according to the needed topology, engineers can allocate storage controllers, switches, and external storage from the SAN component farm. If the available SAN components do not inherently support the needed topology, the SAN emulator 106 can emulate the topology. As a result, the SAN emulator enables engineers to avoid cumbersome equipment procurement and set-up.

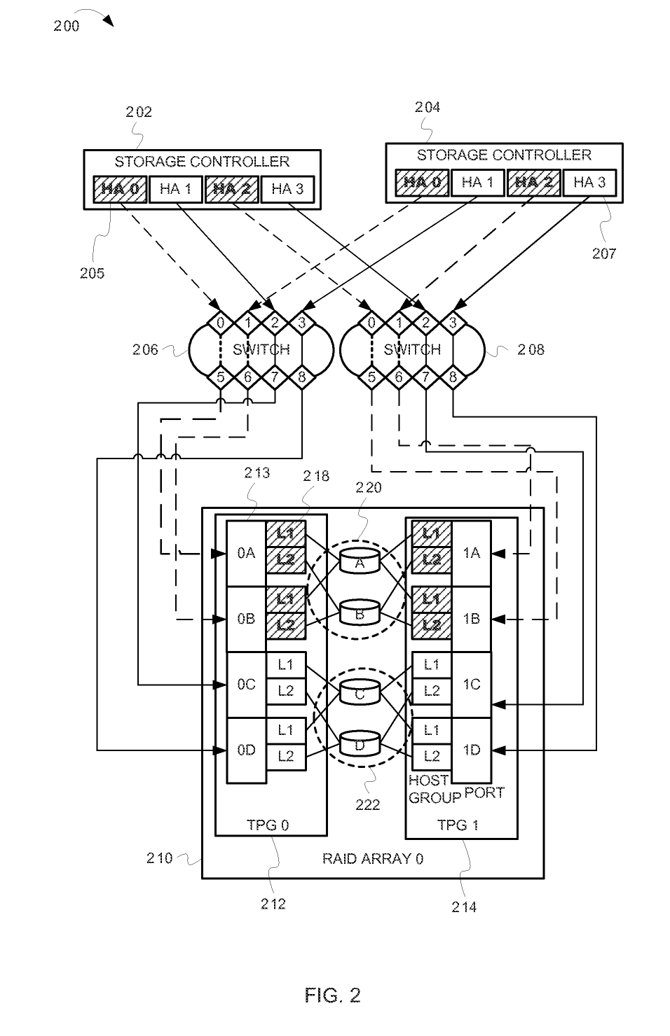

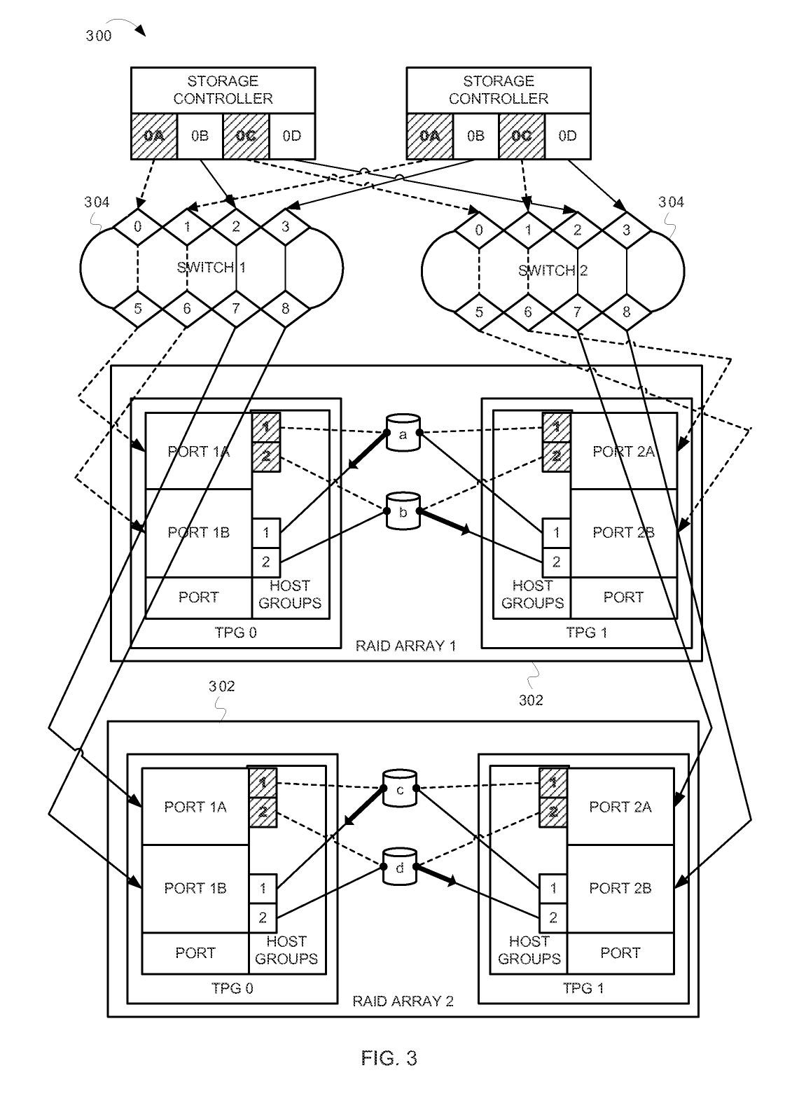

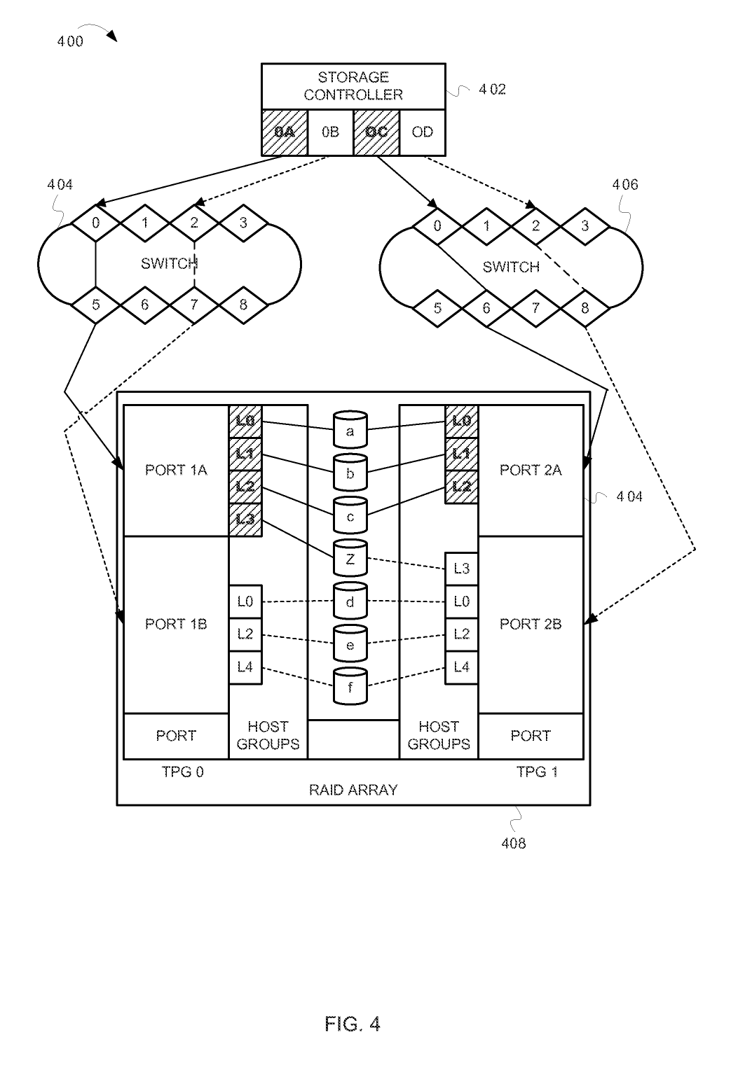

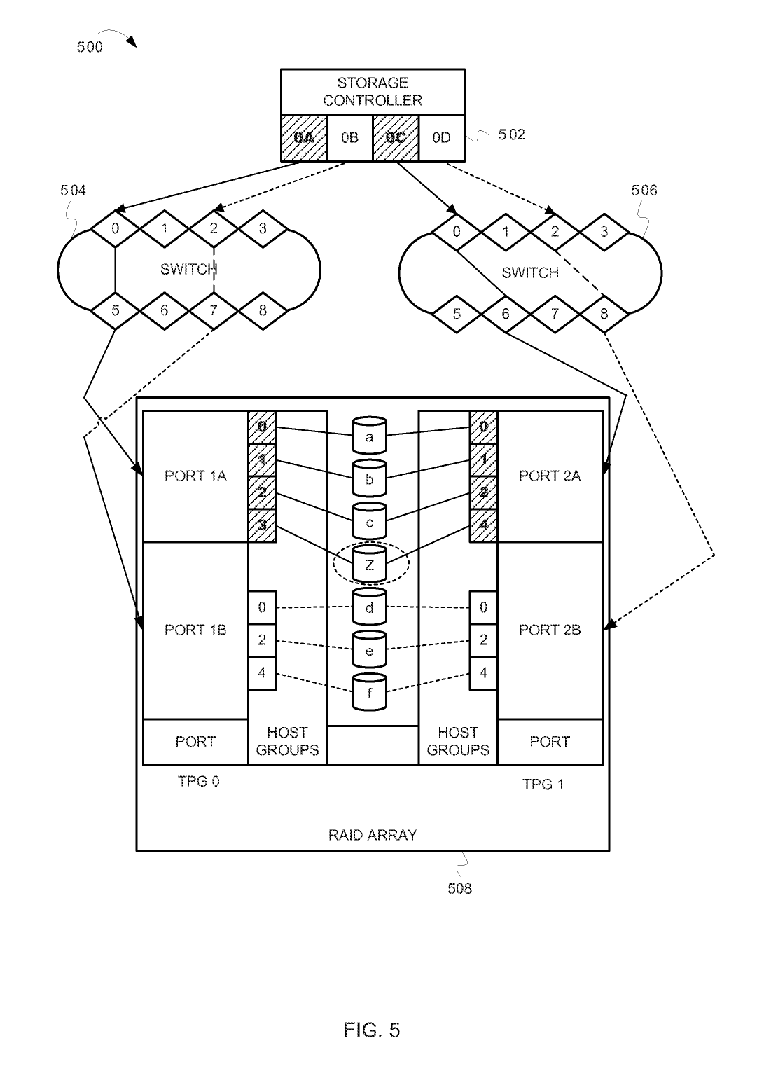

This section describes some example SAN topologies. Some aspects of the SAN emulator can emulate these and other SAN topologies. FIGS. 2 and 3 show properly configured SAN topologies, whereas FIGS. 4 and 5 show improperly configured SAN topologies.

FIG. 2 includes a block diagram illustrating an example SAN topology. In FIG. 2, a SAN 200 includes storage controllers 202 & 204, fiber channel switches 206, 208, and a RAID array 210. As shown, each of the storage controllers 202, 204 includes a set of host bus adapters 205, 207 including host bus adapter HA0, host bus adapter HA1, host bus adapter HA2, host bus adapter HA3. Each of the fiber channel switches 206, 208 includes a set of initiator-side ports including port 0, port 1, port 2, and port 3. Each fiber channel switch 206, 208 also includes a set of target-side ports including port 5, port 6, port 7, and port 8.

The RAID array 210 includes target port groups 212, 214 (also labelled TPG 0 and TPG 1, respectively). TPG 0 has four target ports 213: target port 0A, target port 0B, target port 0C, and target port 0D. TPG 1 has four target ports 213: target port 1A, target port 1B, target port 1C, and target port 1D.

Each target port 213 is associated with two LUNs 218 (L1 and L2) and a LUN group 220. TPG 0's target ports have the following LUN/LUN group associations: target port 0A and target port 0B are associated with LUNs 1 and 2 of LUN group 0 (220), and target port 0C and target port 0D are associated with LUNs 1 and 2 of LUN group 1 (222). TPG 1's target ports have the following LUN/LUN group associations: target port 1A and target port 1B are associated with LUNs 1 and 2 of LUN group 0 (220), and target port 1C and target port 1D are associated with LUNs 1 and 2 of LUN group 1 (222). The RAID array 210 also includes four logical devices 216: device A, device B, device C, and device D. As shown, LUN group 0 (see 220) includes device A and device B, whereas LUN group 1 includes device C and device D (see 222).

Based on the topology in FIG. 2, there are multiple paths by which the storage controllers 202, 204 can access LUNs in the RAID array 210. The storage controllers' host bus adapters HA0 and HA2 are associated with LUN group 0. Therefore, the storage controllers can use host bus adapters HA0 and HA2 to access L1 and L2 of LUN group 0 via paths leading to the logical devices A and B. Similarly, the storage controllers' host bus adapters HA1 and HA3 are associated with LUN group 1. Therefore, the storage controllers can use host bus adapters HA1 and HA3 to access LUNs 1 and 2 of LUN group 1 via paths leading to the logical devices C and D.

FIGS. 3, 4 and 5 describe additional topologies and LUN relationships. FIG. 3 is a block diagram illustrating a SAN topology (300) that includes two RAID arrays 302. In FIG. 3 the switches 304 include paths to two different RAID arrays 302.

The SAN topologies in FIGS. 4 and 5 show how SAN designers/administrators can misconfigure SANs. Because some of the SAN emulators can emulate virtually any given topology, engineers can create comprehensive test cases. FIG. 4 is a block diagram illustrating a misconfigured SAN topology. In FIG. 4, a storage controller 402 is connected to switches 404 and 406, which are connected to a RAID array 408. As shown, the storage controller's host bus adapters 0A and 0C are associated with host group 1 (see hatching), which includes LUNs L0, L1, L2, and L3. Therefore, paths leaving host adapter ports 0A and 0C should lead to each of the LUNs L0, L1, L2, and L3. However, the path leaving the storage controller's host bus adapter 0C will not lead to L3, as the RAID array's target port 2A is not associated with L3. Engineers can use the SAN emulator to emulate the topology 400 to determine how the SAN configuration affects the storage controller OS and/or corrupts data. As a result, engineers can create solutions to prevent such misconfigurations, avoiding negative effects of poor performance and data corruption.

FIG. 5 is a block diagram illustrating another misconfigured SAN topology. In FIG. 5, a storage controller 502 is connected to switches 504 and 506, which are connected to a RAID array 508. Paths leaving host bus adapters 0A and 0C should lead to the same group of LUNs, irrespective of which RAID array target port is on the path. Host bus adapter 0A leads to RAID target port 1A, which is associated with LUNs L0, L1, L2, and L3. However, host bus adapter 0C leads to RAID array target port 2A, which is associated with LUNs L0, L1, L2, and L4. The same LUNs should be associated with RAID array target ports 1A and 2A. However, they are different. To compound matters, logical device Z is associated with LUN 3 on RAID array target port 1A, and LUN 4 on RAID array target port 2A. This is a misconfiguration. Engineers can use the SAN emulator to emulate the topology 500 to determine how the SAN configuration affects SAN performance and/or corrupts data. As a result, engineers can create solutions to prevent such misconfigurations, avoiding negative effects of poor performance and data corruption.

### Example Components and Operations

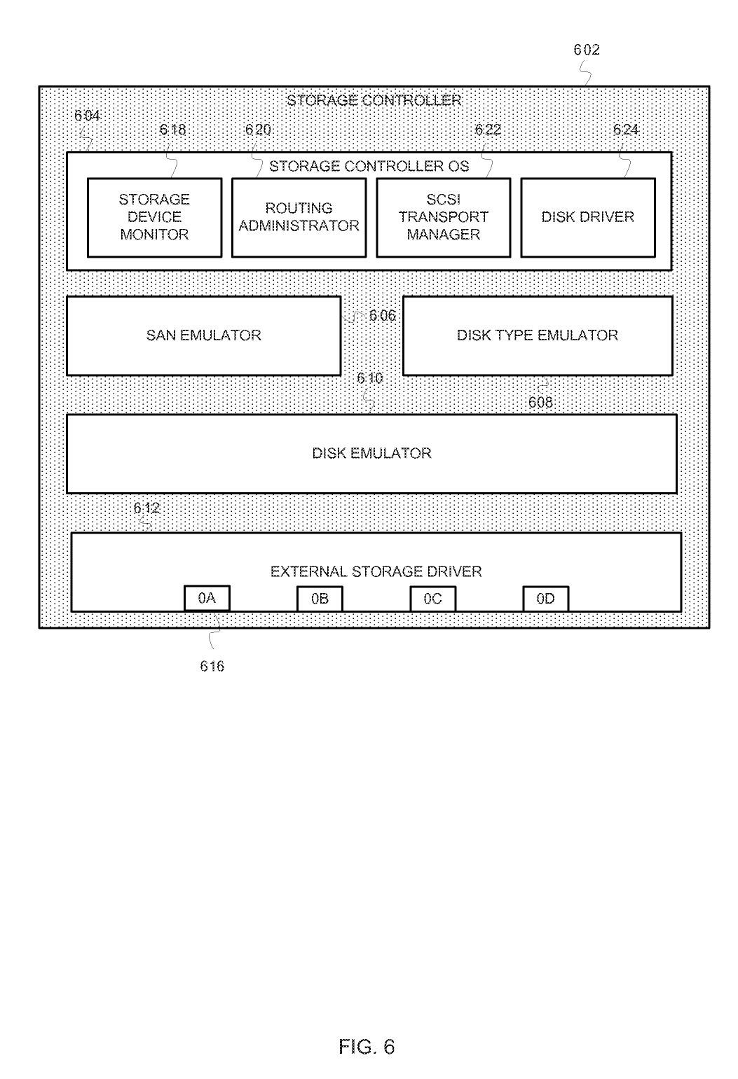

FIG. 6 is a block diagram illustrating an example architecture for a storage controller including a SAN emulator. As shown, the storage controller 602 includes a storage controller OS 604, SAN emulator 606, disk type emulator 608, disk emulator 610, and external storage driver 612. The external storage driver 612 includes ports 616 (0A, 0B, 0C, and 0D), which can be used to establish channels to external storage and virtual SCSI appliance (VSA) devices. The number of ports can vary.

Direct attached storage can be partitioned into SAN-emulated direct attached storage, and disk-emulated direct attached storage. To accomplish this, some of the ports 616 will register direct attached storage with the SAN emulator 606, whereas other ports 616 will register direct attached storage with the disk type emulator 608. For example, all devices seen from port “0A” may register with the SAN emulator 606 through the disk emulator 610 to appear as array LUNs. All devices seen on port “0C” may register with the disk type emulator 608.

In some instances, the external storage driver 612 is limited to a maximum number of devices (e.g., 56 devices). This maximum device limit may impose a limitation on the SAN emulator 606 to support only 56 LUNs. To overcome this limitation, the disk emulator 610 can map “back-end” external storage devices to multiple smaller emulated storage devices, which in turn register with the SAN emulator as individual disks.

In FIG. 6, the storage controller OS 604 includes a storage device monitor 618, routing administrator 620, SCSI transport manager 622, and disk driver 624. The storage device monitor 618 provides basic functionality for monitoring the state of peripheral devices, notifying registered class drivers of state changes, and reporting peripheral/SCSI device type information to the routing administrator 620. In some instances, the SAN emulator 606 resides just below the routing administrator 620 in a component stack. Hence the SAN emulator 606 can exercise (e.g., in testing) the routing administrator 620 for various topologies. In some instances, emulating topologies to the routing administrator 620 is necessary to actually exercise certain components (e.g., certain program code) in the storage controller OS 604.

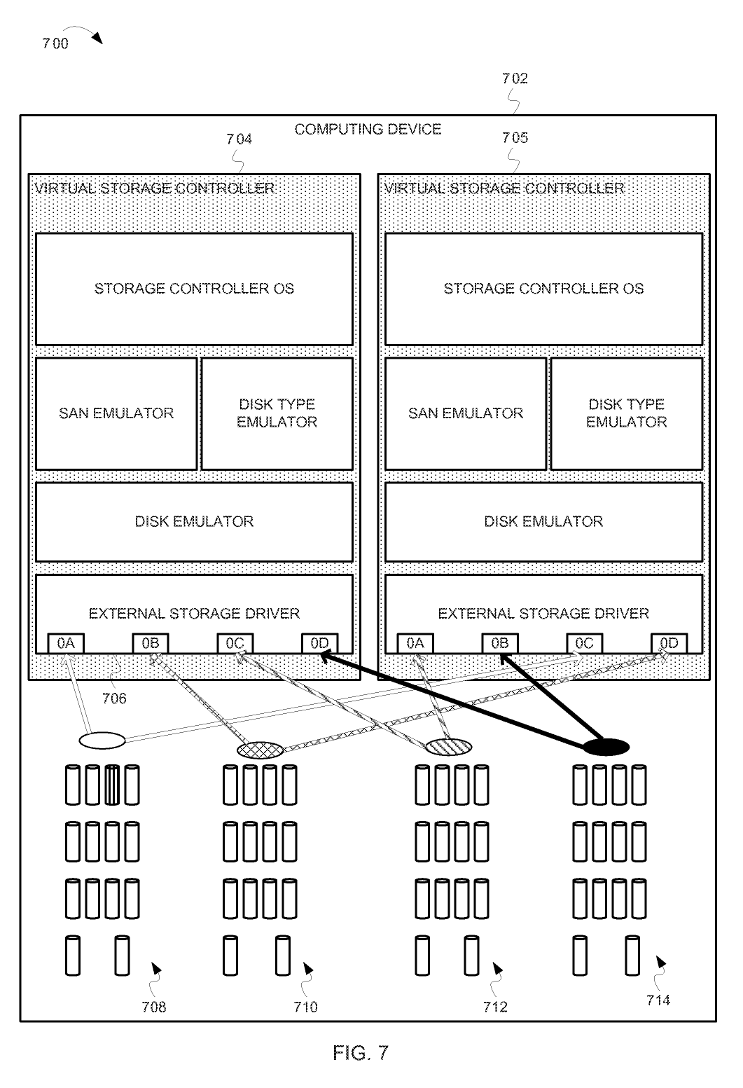

In some instances, the SAN emulator can be part of virtual machines operating on a computing device, such as a VMware ESX server. FIG. 7 is a block diagram illustrating a computing device including virtual storage controllers. As shown, a computing device 702 includes virtual storage controllers 704 and 705. In this example, the virtual storage controllers 704 and 705 include all components, as shown in the storage controller 602 of FIG. 6. In FIG. 7, the external storage driver 706 includes ports 0A, 0B, 0C, and 0D (just as in FIG. 6).

The computing device 702 also includes a storage 708, 710, 712, and 714. As shown, the virtual storage controller 704 connects to the storage 708 and 710 using ports 0A and 0B. Additionally, the virtual storage controller 704 connects to the storage 712 and 714 via ports 0C and 0D. Likewise, the virtual storage controller 705 connects to the storage 712 and 714 via ports 0A and 0B, and storage 708 and 710 via ports 0C and 0D.

Some instances of the SAN emulator support “all mode” and “mixed-mode”. In all-mode, both virtual storage controllers 704 and 705 view all the external storage as LUNs. In mixed mode, external storage on ports 0B and 0D appear as SAS devices. Devices on ports 0A and 0C appear as LUNs. In some instances, LUNs seen from a plurality of virtual storage servers should have the same LUN identifier. For example, LUNS seen by the virtual storage controller 704 on port 0A should have the same LUN identifiers as LUNs seen by the virtual storage controller 705 on port 0C.

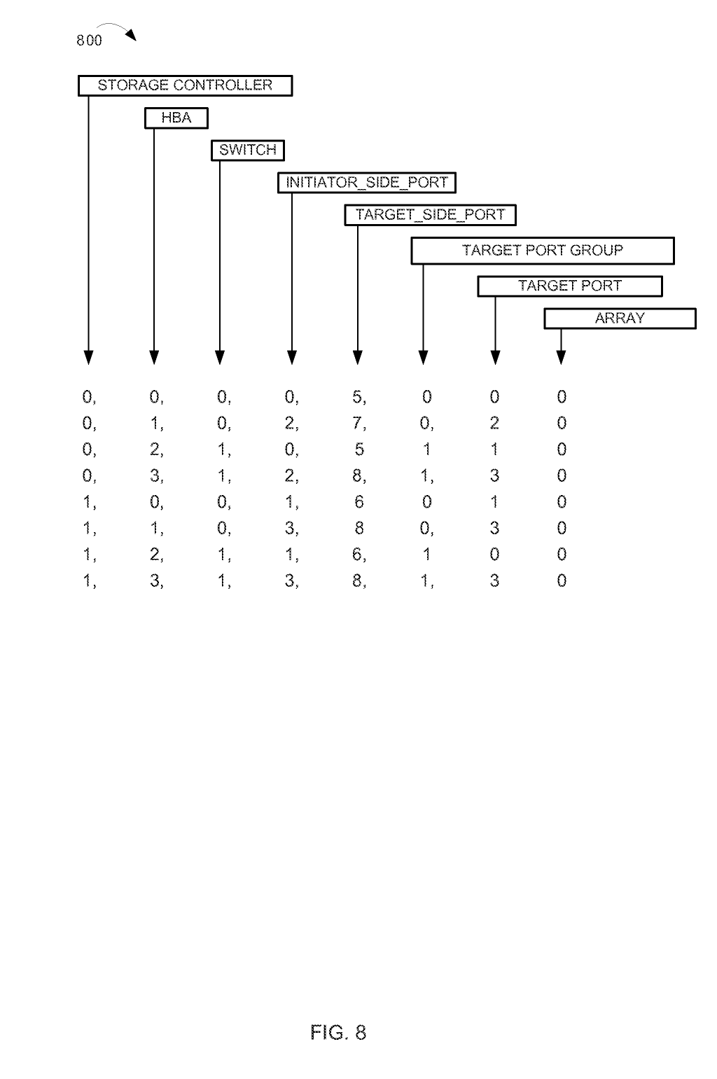

As described above, the SAN emulator can emulate user-defined topologies for SANs. In some instances, the SAN emulator can read the user-defined topologies from a topology matrix. FIG. 8 shows an example topology matrix used for configuring a SAN emulator. In FIG. 8, the topology matrix 800 includes eight rows and eight columns. Each row describes a path to storage. Each column of the row describes a component in the path. As shown, the first column indicates a storage controller. In the first column, there are two different storage controller identifiers—0 and 1. The storage controller identifiers can map to particular storage controllers that may be identified by manufacturer serial number, hardware address, model number, etc.

The matrix's second column identifies a host bus adapter. In the second column, there are four host bus adapter identifiers—0, 1, 2, and 3. The host bus adapter identifiers can map to host bus adapter addresses, such as with the following mappings—0:0A, 1:0B, 2:0C, and 3:0D.

The matrix's third column includes switch identifiers—0 and 1. The switch identifiers identify switches that connect to host bus adapters and controllers. The matrix's fourth and fifth columns include initiator-side-port identifiers and target-side-port identifiers, respectively. The initiator-side-port identifier identifies a storage-controller-side port on the switch. The target-side-port identifier identifies a storage-device-side port on the switch.

The matrix's sixth column includes target port group identifiers, which indicate a target port group. In column 6, there are two different target port group identifiers—0 and 1. The matrix's seventh column includes target port identifiers, which identify a target port on the storage device controller. The matrix's eighth column indicates the RAID array in which the target port group and target port reside.

The SAN emulator may read the topology matrix and determine that the topology includes two storage controllers (two storage controller identifiers in column 1), each storage controller identifier having four host bus adapter ports (four HBA identifiers in column 2). The topology also includes two switches, as indicated by the presence of two switch identifiers in column 3 Each of the two switches has four initiator-side-ports (four identifiers) and four target-side-ports (four identifiers). There is only one RAID array (one identifier), which includes two target port groups (two identifiers), where each target port group includes four target ports (four identifiers).

The SAN emulator can read the topology matrix row by row, and configure data structures to represent the topology in the storage controller. For example, based on the matrix's first row, the SAN emulator can determine that storage controller 0 has an HBA 0 that is connected to initiator-side-port 0 of switch 0. The path leading from initiator-side-port 0 is target-side-port 5, which is connected to target port 0 of target port group 0 of a RAID array 0. As noted, storage controller identifier 0 may map to a particular storage controller serial number or other identifying information about a storage controller. Moreover, the HBA identifiers (0-3) may map to a host bus adapter port, such as 0A, or some other suitable port address. Similarly, the target port identifier (0-3) may map to target port address, such as 0A-0C.

The topology represented in the topology matrix 800 is illustrated in FIG. 2.

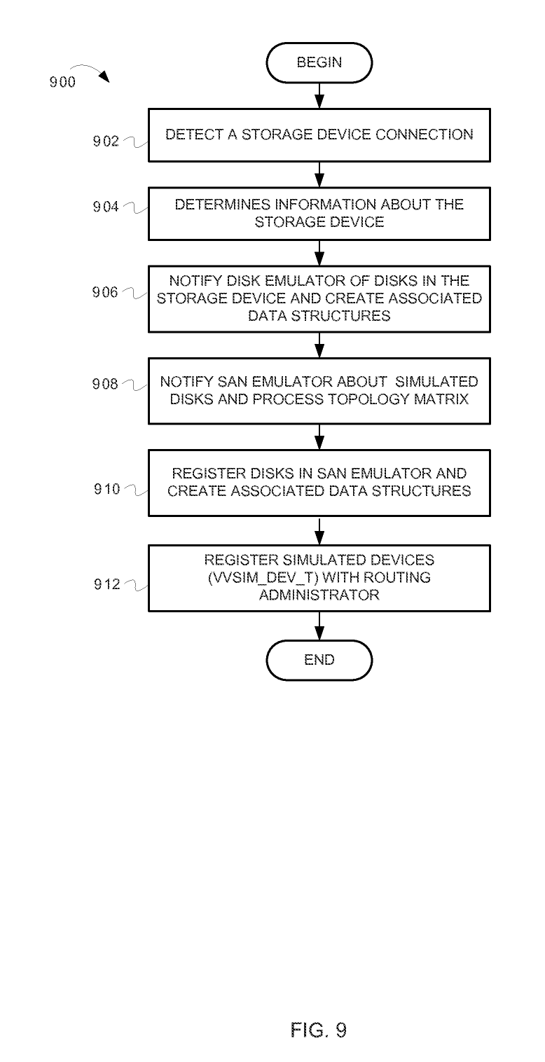

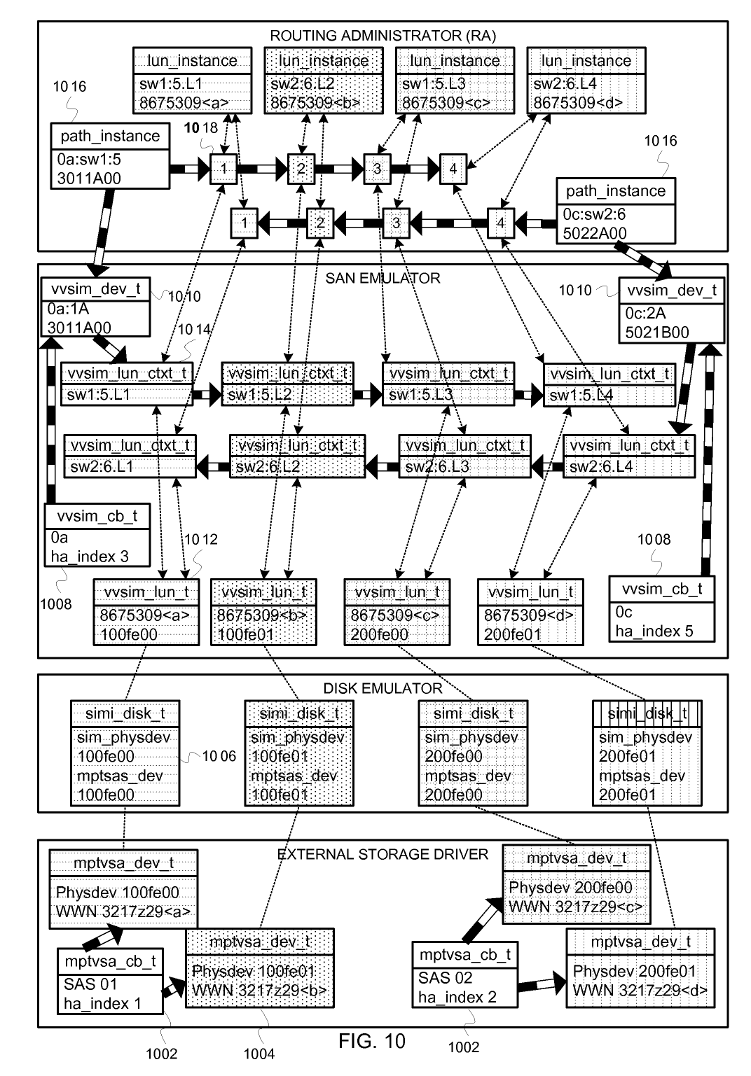

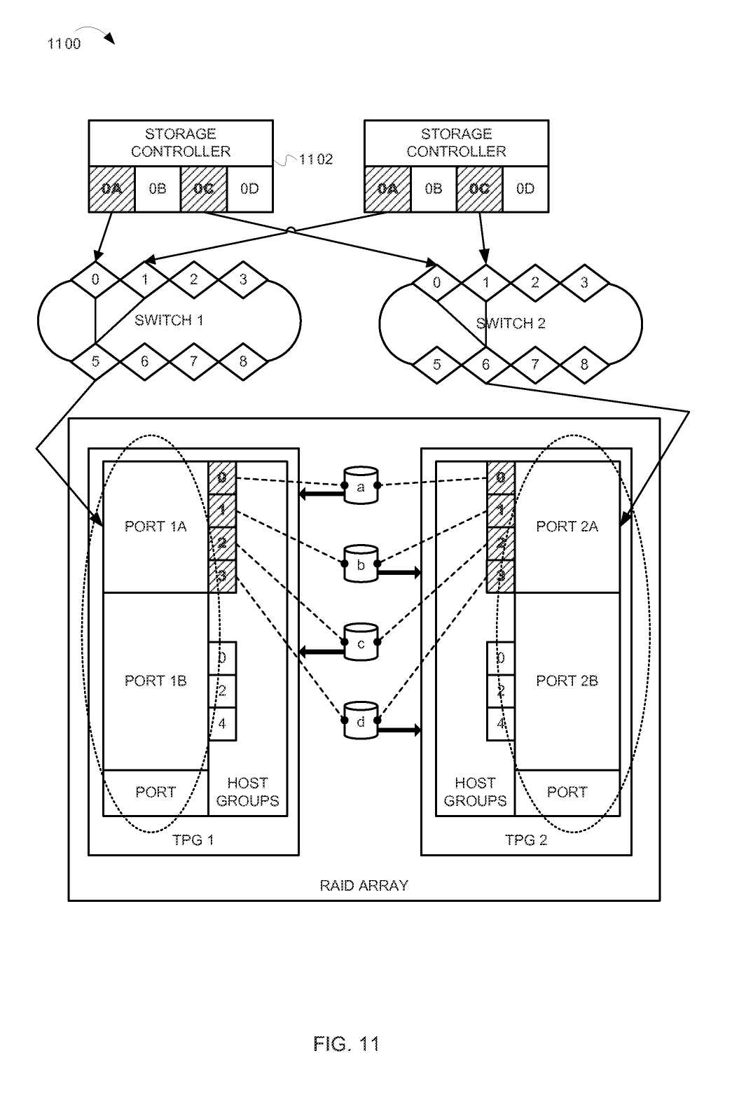

Before the SAN emulator can process I/O requests from the storage controller operating system, it must perform a discovery process, which configures data structures that indicate a SAN topology and how LUNs are mapped to SAN devices. The following discussion describes an example process by which some instances of the SAN emulator perform the discovery process. The discussion refers to FIGS. 9-11. FIG. 9 shows operations for the discovery process, while FIG. 11 shows an example SAN topology with LUN relationships. FIG. 10 shows data structures representing the SAN topology and LUN relationships of FIG. 11.

FIG. 9 is a flow diagram illustrating operations for configuring data structures that indicate a SAN topology and LUN relationships in a SAN. The discovery process of FIG. 9 occurs with respect to the SAN shown in FIG. 11. In FIG. 9, a flow 900 begins at block 902, where an external storage driver detects that a storage device has been connected to the storage controller. The flow continues at block 904.

At block 904, the external storage driver determines information about the storage device, and creates data structures representing aspects of the storage device. For example, the external storage driver creates a control block for each host adapter port in the storage device. Referring to FIG. 10, the external storage driver creates the mptvsa_cb_t structure 1002. The mptvsa_cb_t structure 1002 includes an identifier and host adapter index. Additionally, the external storage driver creates another data structure for each disk associated with the host adapter port. In FIG. 10, external storage driver creates mptvsa_dev_t structures 1004, each including a physical device identifier (e.g., Physdev 100fe01) and a world wide node name (WWNN) as reported by external storage. At this point, the external storage driver can communicated with and keep track of the newly connected storage device. In FIG. 9, the flow continues at block 906.

At block 906, the external storage driver notifies the disk emulator about disks in the recently discovered storage device. Upon receiving notification, the disk emulator creates data structures (siml_disk_t) for each disk of the recently discovered storage device. These data structures (siml_disk_t) represent simulated disks in the disk emulator. In FIG. 10, the siml_disk_t structures 1006 include an identifier that can be used to send I/O to the external storage driver (i.e., mptsas_dev 100fe00) and an identifier that will be reported to the LUN simulator (i.e., sim_physdev 100fe00). The flow 900 continues at block 908.

At block 908, the disk emulator notifies the SAN emulator about the simulated disks. In turn, the SAN emulator reads a topology matrix, and creates data structures based on the topology. Although the topology matrix is not shown, it reflects the topology 1100 shown in FIG. 11. The data structures include a structure for each initiator (vvsim_cb_t), and a structure for each path from initiator to target port on the storage device (vvsim_dev_t). FIG. 10 shows how the SAN emulator creates the vvsim_cb_t structure 1008 for each initiator (i.e., ports 0A and 0C) defined in the topology matrix. In FIG. 10, there are two vvsim_cb_t structures—one for 0A and another for 0C. In FIG. 10, each vvsim_dev_t structure 1010 represents a path from the initiator to target port on the storage device. The vvsim_dev_t structure 1010 includes the initiator port (0a), target port (1A), and other information. In FIG. 10, there are two vvsim_dev_t structures 1010. The flow continues at block 910.

At block 910, in response to the disk emulator's notification (908), the SAN emulator registers the simulated disks. As part of the registration process, the SAN emulator creates a data structure (vvsim_lun_t) for each simulated disk. The vvsim_lun_t structures 1012 include a UID based on a serial number extracted from the WWNN of the external storage disk formatted in a way that indicates the array type being emulated, and the physical device identifier (physdev) of the related simulated disk (siml_disk_t). In FIG. 10, there are four vvsim_lun_t structures 1012.

Also as part of the registration process, for each disk that is registered, the SAN emulator creates a data structure (vvsim_lun_ctxt_t) for each path the disk is on. For the topology 1100 shown in FIG. 11, the SAN emulator creates two vvsim_lun_cxt_t data structures for each registered disk, as each disk appears on two paths (0a:1A and 0c:2A). In FIG. 10, a linked list of vvsim-lun_ctx_t structures 1014 are linked to the vvsim_dev_t structures 1010 to indicate that the LUNs are available on the paths shown in the vvsim_dev_t structures 1010. The flow continues at block 912.

At block 912, the SAN emulator registers its simulated devices (i.e., vvsim_dev_t) with the routing administrator. As part of the registration process, the routing administrator creates a data structure (path_instance) to keep track of the registered simulated devices. In FIG. 10, the routing administrator creates two path_instance structures 1016, which are connected to the vvsim_dev_t structures 1010 in the SAN emulator. The path_instance structures 1016 include a host adapter port (e.g., 0a), switch identifier (e.g., sw1), and switch target-side-port (e.g., 5).

Also as part of the registration process, the routing administrator determines how many LUNs are available on each path (i.e., how many LUNs are available on path 0a:1A and 0c:2A). As shown, there are four available LUNs, so the routing administrator links a linked-list of four structures 1018 onto the path_instance strucutures 1016.

Finally, the registration process creates structures indicating product and serial number information for the LUNs, and target-side switch information for the LUNs. In FIG. 9, the routing administrator issues SCSI commands that determine this information based on the data structures configured during the flow 900.

The discussion of FIG. 9 (above) did not describe all connections and relationships of the data structures shown therein. Some instances of the SAN emulator create all connections shown in FIG. 10.

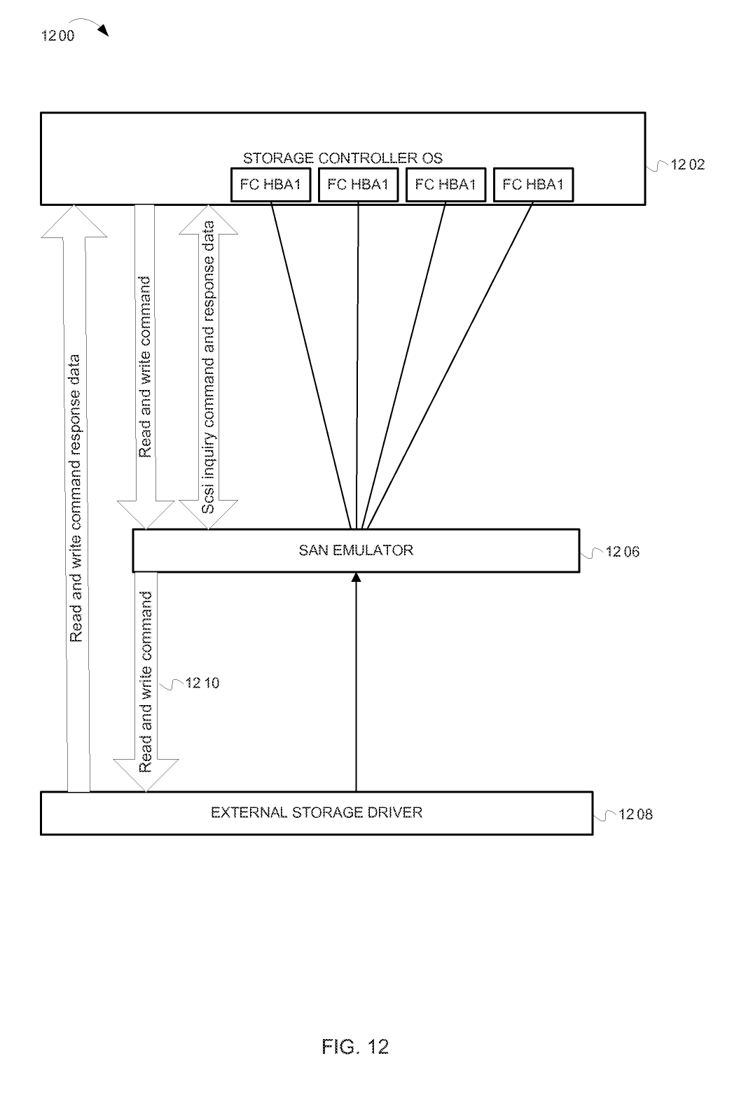

After establishing these data structures, the routing administrator can route I/O requests based on the topology and LUN mappings. For example, using the data structures shown in FIG. 10, the routing administrator can report information about the LUNs, read and write data to the LUNs, and respond to other I/O requests. FIG. 12 shows how some instances of the SAN emulator process I/O requests.

FIG. 12 is a block diagram showing how a SAN emulator and other components of a storage controller can process SCSI I/O commands. FIG. 12 shows components of a storage controller including a storage controller OS 1202, SAN emulator 1206, and external storage driver 1208. As shown, the SAN emulator 1206 can respond to certain SCSI I/O commands without engaging the external storage driver, and without accessing media of connected storage devices. For example, the SAN emulator 1206 itself can respond to the following SCSI I/O commands: SCSI inquiry, report LUNs, mode sends, test unit ready, SCSI start stop unit, SCSI mode select, SCSI request sense, SCSI verify, SCSI maintenance IN, and SCSI maintenance OUT.

As shown, the SAN emulator 1206???? interacts with the external storage driver 1208 for media access commands, such as SCSI read, SCSI write, SCSI write and verify, etc.

As noted above, instances of the SAN emulator emulate vendor specific behavior of different arrays. Because the SAN emulator 1206 itself processes the non-media-access I/O commands, it can emulate various vendor specific behaviors. If the non-media-access I/O commands were passed to the external storage driver 1208, they would be processed like a direct attached disk. Instead, the SAN emulator responds to these commands in vender-specific ways. For example, arrays by different vendors provide different information for certain I/O commands. The SAN emulator can emulate various vendors by providing the same information the vendor's arrays would provide for given I/O commands.

As will be appreciated by one skilled in the art, aspects of the disclosure may be implemented as a system, method or computer program product. Accordingly, aspects of the disclosure may take the form of a hardware aspect, a software aspect (including firmware, resident software, micro-code, etc.) or an aspect combining software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, an electro-magnetic signal, an optical signal, an infrared signal, or any suitable combination thereof. A computer readable signal medium may be any computer readable medium that is not a computer readable storage medium and that can communicate, propagate, or transport a program for use by or in connection with a computer. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone computer, may execute in a distributed manner across multiple computers, and may execute on one computer while providing results and or accepting input on another computer.

Aspects of the disclosure are described with reference to flowchart illustrations and/or block diagrams of methods, apparatus (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

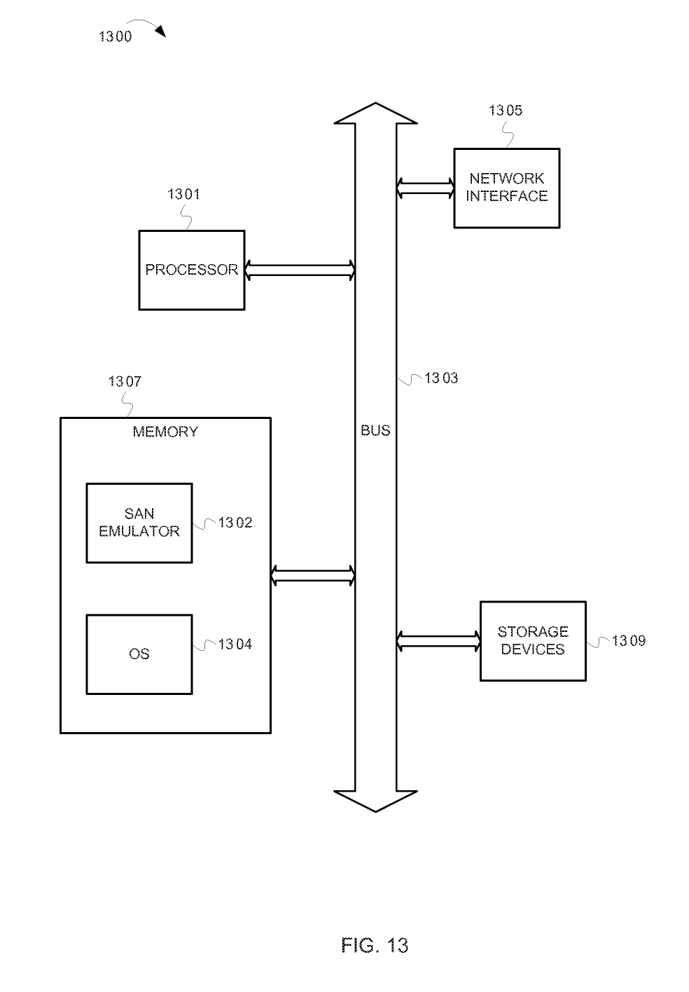

FIG. 13 depicts an example computer system with a cluster consistent logical storage object naming unit. A computer system 1300 includes a processor unit 1301 (possibly including multiple processors, multiple cores, multiple hosts, and/or implementing multi-threading, etc.). The computer system 1300 includes a memory 1307. The memory 1307 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system 1300 also includes a bus 1303 (e.g., PCI, ISA, PCI-Express, HyperTransport® bus, NuBus, etc.), a network interface 1305 (e.g., an ATM interface, an Ethernet interface, a Frame Relay interface, SONET interface, wireless interface, a Fiber Channel interface, an Infiniband® interface, etc.), and a storage device(s) 1309 (e.g., optical storage, magnetic storage, etc.). The processor unit 1301, the storage device(s) 1309, and the network interface 1305 are coupled to the bus 1303. Although illustrated as being coupled to the bus 1303, the memory 1307 may be coupled to the processor unit 1301.

The memory 1307 includes a SAN emulator 1302 and OS 1304. The OS 1304 can be any suitable OS, such as Linux®, Windows®, Apple OS X®, etc. The SAN emulator 1302 can perform any of the operations described above.

While the aspects are described with reference to various aspects and exploitations, it will be understood that these aspects are illustrative and that the scope of the disclosure is not limited to them. In general, techniques for naming logical storage objects in a clustered storage environment as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of . . . or” should not be construed to be exclusive. For instance, the phrase “X comprises at least one of A, B, or C” does not mean that X comprises only one of {A, B, C}; it does not mean that X comprises only one instance of each of {A, B, C}, even if any one of {A, B, C} is a category or sub-category; and it does not mean that an additional element cannot be added to the non-exclusive set (i.e., X can comprise {A, B, Z}).

What is claimed is:

1. A method for testing a storage controller by emulating storage area network (SAN) topologies and vendor-specific behavior in the storage controller, the method comprising:
detecting, via a processor in the storage controller, a physical storage device connected to the storage controller;
in response to detecting the physical storage device,
determining logical unit numbers (LUNs) based on at least one device characteristic of the physical storage device;
determining a SAN topology to emulate, wherein the SAN topology defines paths leading to the LUNs;
updating, via the processor, configuration information used by components of the storage controller to indicate the paths leading to the LUNs;
detecting an input/out request that requires data associated with the LUNs; and
determining, using the configuration information, the data associated with the LUNs.

2. The method of claim 1, wherein the paths trace through host bus adapters on the storage controller, ports on switches in the SAN, and target ports on the physical storage device.

3. The method of claim 1 further comprising:
detecting an input/output request that does not require data associated with the LUNs; and
in response to the input/output request that does not require data associated with the LUNs, providing some of the configuration information.

4. The method of claim 1, wherein the determining, using the configuration information, the data associated with the LUNs further comprises:
providing some of the configuration information to an external storage driver operating in the storage controller.

5. The method of claim 1, wherein determining the SAN topology to emulate includes reading a topology matrix defining paths leading from the storage controller to the LUNs, wherein the paths trace through host bus adapters on the storage controller, ports on switches in the SAN, and target ports on the physical storage device.

6. The method of claim 1 further comprising:
detecting a small computer system interface (SCSI) command that requests information about the LUNs; and
providing the information about the LUNs without interacting with an external disk driver associated with the physical storage device.

7. The method of claim 1, wherein the physical storage device is part of a farm of physical devices used for testing the storage controller.

8. A non-transitory computer readable medium having computer executable code which when executed by at least one computing device, causes the at least one computing device to perform operations for testing a storage controller by emulating storage area network (SAN) topologies and vendor-specific behavior in the storage controller, the operations comprising:
detecting physical storage connected to the storage controller;
in response to detecting the physical storage,
determining logic unit numbers (LUNs) based on at least one device characteristic of the physical storage;
determining a SAN topology to emulate, wherein the SAN topology defines paths leading to the LUNs;
updating configuration information used by components of the storage controller to indicate the paths leading to the LUNs;
detecting an input/out request that requires data associated with the LUNs; and
determining, using the configuration information, the data associated with the LUNs.

9. The non-transitory computer readable medium of claim 8, wherein the paths trace through host bus adapters on the storage controller, ports on switches in the SAN, and target ports on the physical storage.

10. The non-transitory computer readable medium of claim 8 further comprising:
detecting an input/output request that does not require data associated with the LUNs; and
in response to the input/output request that does not require data associated with the LUNs, providing some of the configuration information.

11. The non-transitory computer readable medium of claim 8, wherein the determining, using the configuration information, the data associated with the LUNs further comprises:
providing some of the configuration information to an external storage driver operating in the storage controller.

12. The non-transitory computer readable medium of claim 8, wherein determining the SAN topology to emulate includes reading a topology matrix defining paths leading from the storage controller to the LUNs, wherein the paths trace through host bus adapters on the storage controller, ports on switches in the SAN, and target ports on the physical storage.

13. The non-transitory computer readable medium of claim 8, the operations further comprising:
detecting a small computer system interface (SCSI) command that requests information about the LUNs; and
providing the information about the LUNs without interacting with an external disk driver associated with the physical storage.

14. The non-transitory computer readable medium of claim 8, wherein the physical storage is part of a farm of physical devices used for testing the storage controller.

15. A computing device including:
a processor; and
a non-transitory computer readable medium having computer executable code which when executed by the processor, causes a computing device to perform operations comprising,
detecting physical storage connected to the computing device;
in response to detecting the physical storage,
determining logic unit numbers (LUNs) based on at least one device characteristic of the physical storage;
determining a SAN topology to emulate, wherein the SAN topology defines paths leading to the LUNs;
updating, via the processor, configuration information used by components of the computing device to indicate the paths leading to the LUNs;
detecting an input/out request that requires data associated with the LUNs; and
determining, using the configuration information, the data associated with the LUNs.

16. The computing device of claim 15, wherein the paths trace through host bus adapters on the storage controller, ports on switches in the SAN, and target ports on the physical storage.

17. The computing device of claim 15, the operations further comprising:
detecting an input/output request that does not require data associated with the LUNs; and
in response to the input/output request that does not require data associated with the LUNs, providing some of the configuration information.

18. The computing device of claim 15, wherein the determining, using the configuration information, the data associated with the LUNs further comprises:
providing some of the configuration information to an external storage driver operating in the storage controller.

19. The computing device of claim 15, wherein determining the SAN topology to emulate includes reading a topology matrix defining paths leading from the storage controller to the LUNs, wherein the paths trace through host bus adapters on the storage controller, ports on switches in the SAN, and target ports on the physical storage.

20. The computing device of claim 15, the operations further comprising:
detecting a small computer system interface (SCSI) command that requests information about the LUNs; and
providing the information about the LUNs without interacting with an external disk driver associated with the physical storage.
